(19) United States
(12) Patent Application Publication
(10) Pub. No.: US 2024/0264195 A1
(43) Pub. Date: Aug. 8, 2024

(54) ULTRASONIC TIME MEASUREMENT DEVICE, AND ULTRASONIC TIME MEASUREMENT METHOD

(71) Applicant: FUJI ELECTRIC CO., LTD., Kawasaki-shi (JP)

(72) Inventors: Akira MORITA, Kokubunji-city (JP); Hojun YAMAUCHI, Saitama-city (JP); Yasuyuki MASUNAGA, Miura-gun (JP); Kazuhiro KOIZUMI, Sagamihara-city (JP); Masami KISHIRO, Hino-city (JP); Hideo KANAI, Hachioji-city (JP); Shiori YAMASHITA, Asaka-city (JP)

(73) Assignee: FUJI ELECTRIC CO., LTD., Kawasaki-shi (JP)

(21) Appl. No.: 18/397,431

(22) Filed: Dec. 27, 2023

(30) Foreign Application Priority Data
Feb. 7, 2023 (JP) 2023-016771

(51) Int. Cl. G01P 5/24

(52) U.S. Cl. CPC G01P 5/245

(57) ABSTRACT

An ultrasonic time measurement device measures a propagation time of a measurement wave transmitted from a first sensor to a second sensor. The device includes a transmission circuit that causes the first sensor to repeatedly transmit measurement waves one at a time and a reception circuit that detects reception at the second sensor, of the respective measurement wave transmitted from the first sensor. The device further measures elapsed times for the measurement waves, each of the elapsed times being an elapsed time from a reference time to a reception time of the respective measurement wave received by the second sensor and calculate the propagation time of the measurement wave from the first sensor to the second sensor based on the elapsed times measured by the time measurer.

### CROSS REFERENCE TO RELATED APPLICATION

This Application claims priority from Japanese Patent Application No. 2023-016771 filed on Feb. 7, 2023, the entire contents of which are incorporated herein by reference.

### BACKGROUND

### Field of the Invention

The present disclosure relates to an ultrasonic time measurement device and to an ultrasonic time measurement method.

### Description of Related Art

Measurement devices such as an ultrasonic flow velocity measurement device and an ultrasonic flowmeter that measure the flow velocity or the like of a fluid using ultrasonic waves are known. For example, Japanese Patent Application Laid-Open Publication No. 2000-338123 discloses a method of calculating the flow velocity of a fluid based on a difference between the propagation time of an ultrasonic wave transmitted in the forward direction with respect to a flow of the fluid and the propagation time of the ultrasonic wave transmitted in the reverse direction with respect to the flow of the fluid. The propagation time of the ultrasonic wave transmitted in the forward direction with respect to the flow of the fluid is, for example, the propagation time that elapses before the ultrasonic wave transmitted from a first sensor disposed upstream of the flow of the fluid is received by a second sensor disposed downstream. The propagation time of the ultrasonic wave transmitted in the reverse direction with respect to the flow of the fluid is, for example, the propagation time that elapses before an ultrasonic wave transmitted from the second sensor is received by the first sensor.

Accurate measurement of the propagation time of an ultrasonic wave is desired for a measurement device measuring the flow velocity of a fluid.

### SUMMARY

In view of the above circumstances, an object of one aspect of the present disclosure is to accurately measure the propagation time of an ultrasonic wave.

An ultrasonic time measurement device according to an aspect of this disclosure is an ultrasonic time measurement device that measures a propagation time of a measurement wave transmitted from a first sensor to a second sensor. The device includes a transmission circuit configured to cause the first sensor to repeatedly transmit measurement waves one at a time; a reception circuit configured to detect reception at the second sensor, of the respective measurement wave transmitted from the first sensor; a time measurer configured to measure elapsed times for the measurement waves, each of the elapsed times being an elapsed time from a reference time to a reception time of the respective measurement wave received by the second sensor; and a calculator configured to calculate the propagation time of the measurement wave from the first sensor to the second sensor based on the elapsed times measured by the time measurer.

An ultrasonic time measurement method according to an aspect of this disclosure is an ultrasonic time measurement method for measuring a propagation time of a measurement wave transmitted from a first sensor to a second sensor. The method includes: causing the first sensor to repeatedly transmit measurement waves one at a time; detecting reception at the second sensor, of the respective measurement wave transmitted from the first sensor;
measuring elapsed times for the measurement waves, each of the elapsed times being an elapsed time from a reference time to a reception time of the respective measurement wave received by the second sensor; and calculating the propagation time of the measurement wave from the first sensor to the second sensor based the measured elapsed times.

### BRIEF DESCRIPTION OF THE DRAWINGS

FIG. 1 is an explanatory diagram of an example of a measurement system including an ultrasonic flowmeter according to a first embodiment;

FIG. 2 is a timing chart for explaining an example of different signals in the measurement system illustrated in FIG. 1;

FIG. 3 is a timing chart for explaining an example of different signals according to a comparative example of the measurement system illustrated in FIG. 1;

FIG. 4 is an explanatory diagram of an example of a measurement system including an ultrasonic flowmeter according to a second embodiment; and

FIG. 5 is a timing chart for explaining an example of various signals in the measurement system illustrated in FIG. 4.

### DESCRIPTION OF EMBODIMENTS

Embodiments for implementing the present disclosure are explained below with reference to the drawings. It is to be noted that the dimensions and scales of respective parts in the drawings are different from those of actual products as appropriate. The embodiments described below are a preferred specific example of the present disclosure. Therefore, various technically preferable limitations are added to the embodiments. However, the scope of the present disclosure is not limited to the embodiments unless there are descriptions particularly limiting the present disclosure in the following explanations.

### A: Embodiments

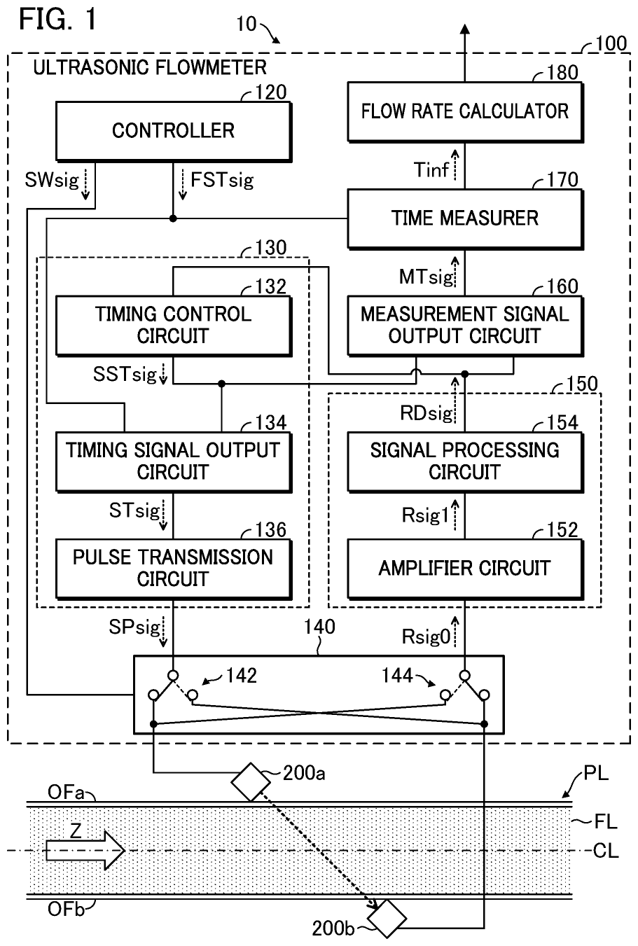

Embodiments of the present disclosure are explained below. An example of the outline of a measurement system 10 according to the embodiments is explained first with reference to FIG. 1.

### A1: First Embodiment

FIG. 1 is an explanatory diagram of an example of the measurement system 10 including an ultrasonic flowmeter 100 according to a first embodiment.

The measurement system 10 is, for example, a system that measures the flow rate of a fluid FL in a pipe PL using an ultrasonic wave. The ultrasonic flowmeter 100 measures the flow rate of the fluid FL in the pipe PL. For example, the measurement system 10 includes the ultrasonic flowmeter 100 and a pair of two ultrasonic sensors 200 (200a and 200b). The ultrasonic flowmeter 100 is an example of an “ultrasonic time measurement device” and the two ultrasonic sensors 200 are examples of a “first sensor” and a “second sensor.” The ultrasonic wave is an example of a “measurement wave.”

Each of the ultrasonic sensors 200a and 200b includes an ultrasonic vibrator that transmits and receives ultrasonic waves. Preferably, the ultrasonic sensors 200a and 200b are disposed on outer faces OF (OFa and OFb) of the pipe PL, for example, in such a manner that the path of the ultrasonic wave transmitted from one to the other of the ultrasonic sensors 200a and 200b passes near a central axis CL of the pipe PL. More preferably, the ultrasonic sensors 200a and 200b are disposed on the outer faces OF of the pipe PL in such a manner that the path of an ultrasonic wave transmitted from one to the other of the ultrasonic sensors 200a and 200b intersects with the central axis CL of the pipe PL. In the example illustrated in FIG. 1, the ultrasonic sensors 200a and 200b are respectively disposed on the outer faces OFa and OFb having tangent planes parallel to each other among the outer faces OF of the pipe PL.

In the example illustrated in FIG. 1, the ultrasonic sensor 200a is disposed upstream the flow of the fluid FL. The ultrasonic sensor 200b is disposed downstream of the flow of the fluid FL. The Z direction in FIG. 1 indicates a direction in which the fluid FL flows. In the example illustrated in FIG. 1, the ultrasonic sensors 200a and 200b are respectively attached to the outer faces OFa and OFb in such a manner that the path of the ultrasonic wave transmitted from one to the other of the ultrasonic sensors 200a and 200b is inclined with respect to the outer faces OFa and OFb of the pipe PL. The ultrasonic wave generated by the ultrasonic sensor 200a or 200b propagates through the pipe PL and the fluid FL at an angle corresponding to the inclination of the ultrasonic sensors 200 with respect to the outer faces OF of the pipe PL. The ultrasonic flowmeter 100 includes a switcher 140. The switcher 140 switches the respective ultrasonic sensor 200 (200a and 200b) so that it functions either as an ultrasonic sensor 200 that transmits the ultrasonic wave or an ultrasonic sensor 200 that receives the ultrasonic wave.

The ultrasonic flowmeter 100 measures (i) the propagation time of the ultrasonic wave transmitted from the ultrasonic sensor 200a to the ultrasonic sensor 200b, and (ii) the propagation time of the ultrasonic wave transmitted from the ultrasonic sensor 200b to the ultrasonic sensor 200a. The ultrasonic flowmeter 100 calculates the flow rate of the fluid FL in the pipe PL based on the measured propagation times of the ultrasonic wave, and the like. In this embodiment, a method (a so-called “sing-around method”) of repeating transmission of the ultrasonic wave from one of the ultrasonic sensors 200a and 200b to the other ultrasonic sensor multiple times is used as a method for measuring the propagation time of the ultrasonic wave. Furthermore, in this embodiment, the number of times of transmission (the number of repetitions of transmission) of an ultrasonic wave, which is repeatedly transmitted from one of the ultrasonic sensors 200a and 200b to the other ultrasonic sensor, is N (N is an integer equal to or greater than 2). Thus, the sum of the propagation times of the ultrasonic wave transmitted N times divided by the value N, obtained as a measurement result of the propagation time of the ultrasonic wave, will improve the resolution of the propagation time of the ultrasonic wave.

For example, the ultrasonic flowmeter 100 includes a controller 120, a transmitter 130, the switcher 140, a receiver 150, a measurement signal output circuit 160, a time measurer 170, and a flow rate calculator 180. The transmitter 130 is an example of a “transmission circuit” and the receiver 150 is an example of a “reception circuit”. The flow rate calculator 180 is an example of a “calculator”.

The controller 120 controls components of the ultrasonic flowmeter 100. The controller 120 may be realized by hardware such as a GPU (Graphics Processing Unit), a DSP (Digital Signal Processor), or an FPGA (Field Programmable Gate Array). Alternatively, the controller 120 may be a processor that controls the components of the ultrasonic flowmeter 100. Specifically, the controller 120 may be configured to include, for example, one or more CPUs (Central Processing Units). In this case, the controller 120 functions as a functional block that controls the components of the ultrasonic flowmeter 100, for example, by executing a control program read from a storage device (not illustrated).

For example, in a case in which the controller 120 is configured to include CPUs, some or all of the functions of the controller 120 may be realized by the CPUs that cooperate in accordance with a program such as the control program. The controller 120 may be configured to include one or more CPUs, and hardware such as a GPU, a DSP, or an FPGA. In this case, some or all of the functions of the controller 120 may be realized by the hardware such as the DSP.

For example, the controller 120 generates a switching signal SWsig for switching the respective ultrasonic sensor 200, to function either as a transmitter of ultrasonic waves or a receiver of ultrasonic waves, and outputs the generated switching signal SWsig to the switcher 140. That is, the controller 120 controls switching between measurement of the propagation time of the ultrasonic wave that propagates from an upstream to a downstream with respect to the flow of the fluid FL, and measurement of the propagation time of the ultrasonic wave that propagates from the downstream to the upstream with respect to the flow of the fluid FL. Hereinafter, a direction from the upstream to the downstream with respect to the flow of the fluid FL is also referred to as a “forward direction” relative to the flow of the fluid FL, and a direction from the downstream side to the upstream side with respect to the flow of the fluid FL is also referred to as a “reverse direction” relative to the flow of the fluid FL.

The controller 120 also generates a first transmission timing signal FSTsig that defines the transmission timing of an ultrasonic wave to be transmitted first, from among ultrasonic waves that are repeatedly transmitted, and outputs the generated first transmission timing signal FSTsig to the transmitter 130 and the time measurer 170. The transmission timing of the ultrasonic wave corresponds to the transmission time of the ultrasonic wave.

The transmitter 130 causes an ultrasonic sensor 200 to repeatedly transmit an ultrasonic wave. In other words, the transmitter 130 causes the ultrasonic sensor 200 to repeatedly transmit ultrasonic waves one at a time. For example, the transmitter 130 drives the ultrasonic sensor 200a or 200b in accordance with an instruction from the controller 120 to transmit the ultrasonic wave to the fluid FL in the pipe PL. Specifically, the transmitter 130 transmits a transmission pulse signal SPsig for driving the ultrasonic sensor 200a or 200b to the ultrasonic sensor 200a or 200b via the switcher 140.

For example, the transmitter 130 includes a timing control circuit 132, a timing signal output circuit 134, and a pulse transmission circuit 136.

The timing control circuit 132 includes, for example, a delay circuit (not illustrated). For example, the timing control circuit 132 receives from the receiver 150, a reception detection signal RDsig that indicates reception of the ultrasonic wave at the ultrasonic sensor 200a or 200b, and delays the reception detection signal RDsig. The timing control circuit 132 generates a subsequent transmission timing signal SSTsig that defines transmission timings of ultrasonic waves to be transmitted for the second and subsequent times, from among the ultrasonic waves that are repeatedly transmitted, based on a signal obtained by delaying the reception detection signal RDsig. The subsequent transmission timing signal SSTsig is output from the timing control circuit 132 to the timing signal output circuit 134 and the measurement signal output circuit 160.

The timing signal output circuit 134 receives the first transmission timing signal FSTsig from the controller 120 and receives the subsequent transmission timing signal SSTsig from the timing control circuit 132. Based on the first transmission timing signal FSTsig and the subsequent transmission timing signal SSTsig, the timing signal output circuit 134 generates a transmission timing signal STsig that defines the transmission timing of each of the ultrasonic waves that are repeatedly transmitted. The transmission timing signal STsig is output from the timing signal output circuit 134 to the pulse transmission circuit 136.

The configuration of the timing signal output circuit 134 is not limited thereto, and the timing signal output circuit 134 may be an OR circuit. In this case, the result of logical OR of the first transmission timing signal FSTsig and the subsequent transmission timing signal SSTsig corresponds to the transmission timing signal STsig. For example, the timing signal output circuit 134 may be a selection circuit that selects either the first transmission timing signal FSTsig or the subsequent transmission timing signal SSTsig to output the selected signal as the transmission timing signal STsig to the pulse transmission circuit 136. In this case, after the first transmission timing signal FSTsig is selected as the transmission timing signal STsig, the subsequent transmission timing signal SSTsig is selected as the transmission timing signal STsig.

The pulse transmission circuit 136 transmits, for example, the transmission pulse signal SPsig for driving an ultrasonic sensor 200 to the ultrasonic sensor 200a or 200b via the switcher 140 in accordance with the transmission timing of the ultrasonic wave indicated by the transmission timing signal STsig. In this embodiment, since the transmission timing of the ultrasonic wave is repeatedly indicated by the transmission timing signal STsig, the pulse transmission circuit 136 repeatedly transmits the transmission pulse signal SPsig to the ultrasonic sensor 200a or 200b. Consequently, an ultrasonic wave is repeatedly transmitted from one of the ultrasonic sensors 200a and 200b.

An ultrasonic wave repeatedly transmitted from one of the ultrasonic sensor 200a and 200b is received by the other of the ultrasonic sensors 200a and 200b. A reception signal Rsig0 corresponding to the ultrasonic wave received by the ultrasonic sensor 200a or 200b is received by an amplifier circuit 152, which will be described later, via the switcher 140. The reception signal Rsig0 is a signal obtained by converting the ultrasonic wave, having reached the ultrasonic sensor 200, to an electrical signal in the ultrasonic sensor 200 (more specifically, an ultrasonic vibrator included in the ultrasonic sensor 200).

The switcher 140 switches the ultrasonic sensor 200 (200a and 200b) between the transmitter of ultrasonic waves and the receiver of ultrasonic waves in response to the switching signal SWsig received from the controller 120. For example, the switcher 140 includes switches 142 and 144.

The switch 142 connects the pulse transmission circuit 136 to one of the ultrasonic sensors 200a and 200b in response to the switching signal SWsig. That is, the switch 142 switches the output destination of the transmission pulse signal SPsig output from the pulse transmission circuit 136 to either the ultrasonic sensor 200a or 200b in accordance with the switching signal SWsig.

The switch 144 connects the amplifier circuit 152 to either the ultrasonic sensor 200a or 200b in accordance with the switching signal SWsig. That is, the switch 144 switches the supply source of the reception signal Rsig0 to be received by the amplifier circuit 152 to either the ultrasonic sensor 200a or 200b in accordance with the switching signal SWsig. The switches 142 and 144 are controlled in such a manner that one of the ultrasonic sensors 200a and 200b is connected to the pulse transmission circuit 136 and that the other of the ultrasonic sensors 200a and 200b is connected to the amplifier circuit 152.

In this embodiment, the switcher 140 switches transmission and reception of the ultrasonic wave between the ultrasonic sensors 200a and 200b in accordance with the switching signal SWsig. Hereinafter, of the ultrasonic sensors 200a and 200b, an ultrasonic sensor 200 connected to the pulse transmission circuit 136 via the switch 142 is referred to also as an “ultrasonic sensor 200 in a transmission mode”. Of the ultrasonic sensors 200a and 200b, an ultrasonic sensor 200 connected to the amplifier circuit 152 via the switch is hereinafter referred to also as an “ultrasonic sensor 200 in a reception mode”. The ultrasonic sensor 200 in the transmission mode is an example of a “first sensor” and the ultrasonic sensor 200 in the reception mode is an example of a “second sensor”.

The receiver 150 detects reception of the ultrasonic wave transmitted from the ultrasonic sensor 200 in the transmission mode by the ultrasonic sensor 200 in the reception mode. For example, the receiver 150 has the amplifier circuit 152 and a signal processing circuit 154.

The amplifier circuit 152 receives the reception signal Rsig0 corresponding to the ultrasonic wave received by the ultrasonic sensor 200 in the reception mode, from the ultrasonic sensor 200 in the reception mode via the switch 144. The amplifier circuit 152 amplifies the reception signal Rsig0 received from the ultrasonic sensor 200 in the reception mode and outputs the amplified reception signal Rsig0 as a reception signal Rsig1 to the signal processing circuit 154.

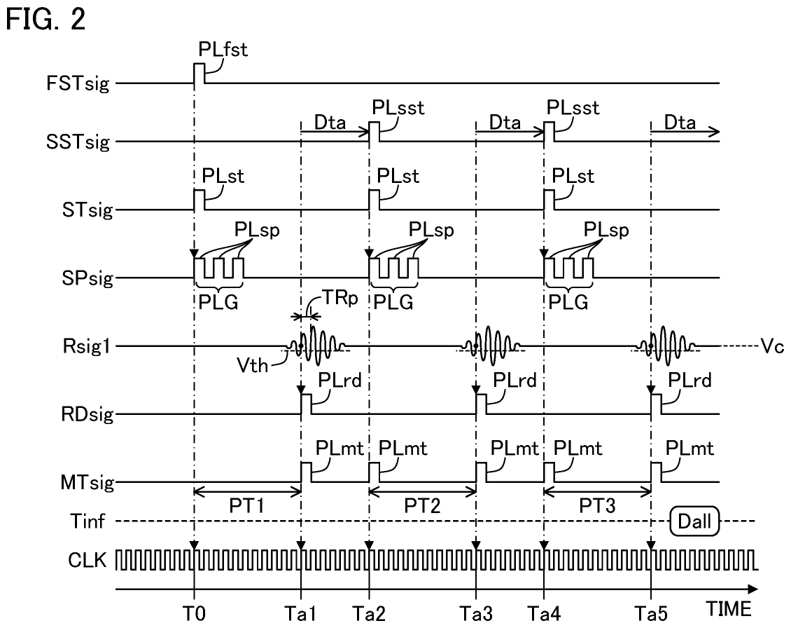

The signal processing circuit 154 generates the reception detection signal RDsig indicating reception of the ultrasonic wave by the ultrasonic sensor 200 in the reception mode, based on the reception signal Rsig1 received from the amplifier circuit 152. For example, the signal processing circuit 154 generates the reception detection signal RDsig indicating the reception timing when the ultrasonic sensor 200 in the reception mode has received the ultrasonic wave, based on the reception signal Rsig1. The reception timing of the ultrasonic wave corresponds to the reception time of the ultrasonic wave. The generation method of the reception detection signal RDsig will be explained with reference to FIG. 2, described later. The reception detection signal RDsig is output from the signal processing circuit 154 to the measurement signal output circuit 160.

The measurement signal output circuit 160 receives the subsequent transmission timing signal SSTsig from the timing control circuit 132 and receives the reception detection signal RDsig from the signal processing circuit 154. The measurement signal output circuit 160 generates a measurement signal MTsig for measuring an elapsed time from a reference time to a transmission time of the ultrasonic wave, and an elapsed time from the reference time to a reception time of the ultrasonic wave, based on the subsequent transmission timing signal SSTsig and the reception detection signal RDsig. The measurement signal MTsig is output from the measurement signal output circuit 160 to the time measurer 170.

The reference time is, for example, the transmission time of an ultrasonic wave transmitted first from among the ultrasonic waves repeatedly transmitted from the ultrasonic sensor 200 in the transmission mode. For example, the transmission timing of the ultrasonic wave indicated by the first transmission timing signal FSTsig corresponds to the transmission time of the ultrasonic wave that was transmitted first.

To be measured as an elapsed time from the reference time is an elapsed time from the reference time to the transmission time of each of ultrasonic waves transmitted for the second and subsequent times from among the ultrasonic waves repeatedly transmitted from the ultrasonic sensor 200 in the transmission mode. For example, each of transmission timings of the ultrasonic wave indicated by the subsequent transmission timing signal SSTsig corresponds to the transmission time of each of the ultrasonic waves transmitted for the second and subsequent times.

The reception time of the ultrasonic wave is, for example, the reception time of each of ultrasonic waves repeatedly received by the ultrasonic sensor 200 in the reception mode. For example, each of reception timings of the ultrasonic wave indicated by the reception detection signal RDsig corresponds to the reception time of each of the ultrasonic waves repeatedly received by the ultrasonic sensor 200 in the reception mode.

The configuration of the measurement signal output circuit 160 is not limited thereto, and the measurement signal output circuit 160 may be, for example, an OR circuit. In this case, the result of logical OR of the subsequent transmission timing signal SSTsig and the reception detection signal RDsig corresponds to the measurement signal MTsig. For example, the measurement signal output circuit 160 may be a selection circuit that selects one of the subsequent transmission timing signal SSTsig and the reception detection signal RDsig to output the selected signal as the measurement signal MTsig to the time measurer 170. In this case, for example, the reception detection signal RDsig and the subsequent transmission timing signal SSTsig are alternately selected as the measurement signal MTsig.

The time measurer 170 measures the elapsed time from the reference time to the transmission time of the ultrasonic wave and the elapsed time from the reference time to the reception time of the ultrasonic wave based on the first transmission timing signal FSTsig and the measurement signal MTsig. For example, upon receipt of the first transmission timing signal FSTsig, the time measurer 170 starts counting clock pulses CLK illustrated in FIG. 2 (for example, rising edges or falling edges of the clock pulses CLK). The time measurer 170 stores count values each obtained at each of transmission timings and reception timings of the ultrasonic wave indicated by the measurement signal MTsig. The transmission timings or reception timings of the ultrasonic wave indicated by the measurement signal MTsig are transmission or reception timings that have been measured, and will sometimes be collectively referred to as “measurement timings” in the following description. In this embodiment, it is envisaged that the time measurer 170 has an oscillation circuit that generates the clock pulses CLK. However, the time measurer 170 may receive the clock pulses CLK from outside the time measurer 170.

The elapsed time from the reference time to each measurement timing is calculated, for example, by a product of (i) the count value stored at the measurement timing and (ii) a cycle of the clock pulse CLK. Storing the count value at each of the transmission timings of the ultrasonic wave indicated by the measurement signal MTsig means (i) measuring the elapsed time from the reference time to each of transmission times of the ultrasonic wave repeatedly transmitted and (ii) storing the measured elapsed time. Similarly, storing the count value at each of the reception timings of the ultrasonic wave indicated by the measurement signal MTsig means (i) measuring the elapsed time from the reference time to each of reception times of the ultrasonic wave repeatedly transmitted and (ii) storing the measured elapsed time.

The time measurer 170 outputs time information Tinf to the flow rate calculator 180 after the ultrasonic sensor 200 in the transmission mode has repeated transmission of the ultrasonic wave a predetermined number of times. For example, the time measurer 170 outputs, as the time information Tinf, data Dall (see FIG. 2) indicating the count values stored in accordance with the measurement signal MTsig. For example, the time measurer 170 outputs the time information Tinf to the flow rate calculator 180 after the elapsed time from the reference time to the reception time of an Nth transmitted ultrasonic wave has been measured. In this case, the time information Tinf corresponds to time information indicating the elapsed time from the reference time to the reception time of each of first to the Nth transmitted ultrasonic waves, and the elapsed time from the reference time to the transmission time of each of second to the Nth transmitted ultrasonic waves.

In this embodiment, the time measurer 170 can measure an elapsed time from the reference time to the respective measurement timing using the measurement signal MTsig, which indicates the transmission timing of a ultrasonic wave and the reception timing of the ultrasonic wave.

The flow rate calculator 180 calculates the propagation time of the ultrasonic wave from the ultrasonic sensor 200 in the transmission mode to the ultrasonic sensor 200 in the reception mode based on the time information Tinf received from the time measurer 170. Specifically, the flow rate calculator 180 calculates the propagation time of the ultrasonic wave from the ultrasonic sensor 200 in the transmission mode to the ultrasonic sensor 200 in the reception mode based on the elapsed times measured by the time measurer 170. The flow rate calculator 180 calculates the flow velocity of the fluid FL in the pipe PL based on the calculated propagation time of the ultrasonic wave. Furthermore, the flow rate calculator 180 calculates the flow rate of the fluid FL in the pipe PL based on the flow velocity of the fluid FL in the pipe PL and the cross-sectional area of the pipe PL.

A known method can be adopted as the method for calculating the flow velocity of the fluid FL in the pipe PL based on the propagation time of the ultrasonic wave. For example, the flow rate calculator 180 may calculate the flow velocity of the fluid FL in the pipe PL using a propagation time inverse difference method in which effects of temperature dependency of the fluid FL (for example, temperature dependency of the sound speed) are small. In the propagation time inverse difference method, for example, the flow velocity of the fluid FL is calculated based on the difference between the inverse of the propagation time of the ultrasonic wave in the forward direction with respect to the flow of the fluid FL and the inverse of the propagation time of the ultrasonic wave in the reverse direction with respect to the flow of the fluid FL. If the propagation time inverse difference method is used to calculate the flow velocity of the fluid FL, the controller 120 switches between the ultrasonic sensor 200 in the transmission mode and the ultrasonic sensor 200 in the reception mode to change the propagation direction of the ultrasonic wave.

In the example illustrated in FIG. 1, the pulse transmission circuit 136 is connected to the ultrasonic sensor 200a via the switch 142, and the amplifier circuit 152 is connected to the ultrasonic sensor 200b via the switch 144. In this case, ultrasonic waves generated in the ultrasonic sensor 200a in response to the transmission pulse signal SPsig from the pulse transmission circuit 136 pass through the pipe PL and enter the fluid FL in the pipe PL. An ultrasonic wave having entered the fluid FL in the pipe PL passes through the pipe PL and is propagated to the ultrasonic sensor 200b. The ultrasonic wave propagated to the ultrasonic sensor 200b is converted by the ultrasonic sensor 200b to a reception signal Rsig0, which is an electrical signal. The reception signal Rsig0 is received via the switch 144 by the amplifier circuit 152, at which the reception signal Rsig0 is amplified. The signal processing circuit 154 outputs, to the measurement signal output circuit 160, a reception detection signal RDsig generated based on a reception signal Rsig1 obtained by amplifying the reception signal Rsig0. Consequently, the time measurer 170 measures multiple elapsed times from the reference time to the measurement timings in a case in which the ultrasonic waves are transmitted in the forward direction, to output to the flow rate calculator 180 the time information Tinf indicating the measured elapsed times.

The controller 120 controls the switcher 140, for example, after the time measurer 170 has measured an elapsed time from the reference time to the reception time of the Nth transmitted ultrasonic wave, thereby switching between the ultrasonic sensor 200 in the transmission mode and the ultrasonic sensor 200 in the reception mode. Consequently, multiple elapsed times from the reference time to the measurement timings in a case in which ultrasonic waves are transmitted in the reverse direction are measured by the time measurer 170, and the time information Tinf indicating the elapsed times measured by the time measurer 170 is output to the flow rate calculator 180. The flow rate calculator 180 calculates the propagation times in two directions including the forward direction and the reverse direction with respect to the flow of the fluid FL, based on the elapsed times measured by the time measurer 170. The flow rate calculator 180 calculates the flow velocity of the fluid FL in the pipe PL based on a difference between the following two inverses: (i) an inverse of the propagation time of the ultrasonic wave in one direction, and (ii) an inverse of the propagation time of the ultrasonic wave in the other direction. That is, the flow rate calculator 180 calculates the flow velocity of the fluid FL in the pipe PL based on the difference between (i) the inverse of the propagation time of the ultrasonic wave propagating from the ultrasonic sensor 200a to the ultrasonic sensor 200b, and (ii) the inverse of the propagation time of the ultrasonic wave propagating from the ultrasonic sensor 200b to the ultrasonic sensor 200a.

The configurations of the measurement system 10 and the ultrasonic flowmeter 100 are not limited to the example illustrated in FIG. 1. For example, the timing control circuit 132 may be included in the controller 120. The timing control circuit 132 and the timing signal output circuit 134 may be included in the controller 120. Alternatively, the timing signal output circuit 134 may be included in the pulse transmission circuit 136. The measurement signal output circuit 160 may be included in the time measurer 170. In a case in which the time measurer 170 receives the clock pulses CLK from outside the time measurer 170, the oscillation circuit that generates the clock pulses CLK may be included in the ultrasonic flowmeter 100 or may be provided outside the ultrasonic flowmeter 100.

Example timings of various signals for measuring the propagation time of the ultrasonic wave are explained next with reference to FIG. 2.

FIG. 2 is a timing chart for explaining examples of signals in the measurement system 10 illustrated in FIG. 1. FIG. 2 illustrates example timings of different signals for measuring the propagation time of the ultrasonic wave transmitted in one of the forward direction and the reverse direction. It is envisaged that the time measurer 170 can hold five count values in FIG. 2. However, the number of count values that can be stored by the time measurer 170 is not limited to five. FIG. 2 assumes a case in which the number of times (N times) of transmission of the ultrasonic wave repeatedly transmitted from one to the other of the ultrasonic sensors 200a and 200b is three.

Hereinafter, the propagation time of the respective ultrasonic wave repeatedly transmitted is also referred to as an “individual propagation time PT (PT1, PT2, PT3)”. In FIG. 2, a number (1, 2, or 3) that indicates the order of transmitted ultrasonic waves added to the end of a sign denoting the individual propagation time PT distinguishes the individual propagation times PT from each other.

The first transmission timing signal FSTsig includes a pulse PLfst that defines the transmission timing of an ultrasonic wave transmitted first. The subsequent transmission timing signal SSTsig includes pulses PLsst that each define each of the transmission timings of ultrasonic waves transmitted second and later. The transmission timing signal STsig includes (i) a pulse PLst of the first transmission timing signal FSTsig, and (i) pulses PLsst included in the subsequent transmission timing signal SSTsig. Therefore, the transmission timing of each of the ultrasonic waves is defined by the corresponding pulse PLst of the transmission timing signal STsig. In the example illustrated in FIG. 2, the result of logical OR of the first transmission timing signal FSTsig and the subsequent transmission timing signal SSTsig corresponds to the transmission timing signal STsig.

The transmission pulse signal SPsig includes pulse groups PLG each including multiple (three in the example illustrated in FIG. 2) pulses PLsp. Each of the pulses PLsp is, for example, a high-voltage pulse applied to the ultrasonic sensor 200 in the transmission mode. For example, the pulse groups PLG are output from the pulse transmission circuit 136 at timings defined by the pulses PLst of the transmission timing signal STsig. In the example illustrated in FIG. 2, a first pulse group PLG is output from the pulse transmission circuit 136 at a time T0 defined by a first pulse PLst of the transmission timing signal STsig. Accordingly, an ultrasonic wave in response to the pulses PLsp included in the first pulse group PLG of the transmission pulse signal SPsig is generated in the ultrasonic sensor 200 in the transmission mode.

The time T0 defined by the first pulse PLst of the transmission timing signal STsig corresponds to a time defined by the pulse PLfst of the first transmission timing signal FSTsig. Therefore, the time measurer 170 having received the pulse PLfst of the first transmission timing signal FSTsig starts counting the clock pulses CLK at the time T0. The time T0 is the reference time. Thus, the time measurer 170 starts measurement of the elapsed time from the reference time upon receipt of the pulse PLfst of the first transmission timing signal FSTsig.

As explained with reference to FIG. 1, the reception signal Rsig1 is a signal obtained by amplifying the reception signal Rsig0 output from the ultrasonic sensor 200 in the reception mode. A voltage Vc illustrated in FIG. 2 is a voltage of the reception signal Rsig1 received by the signal processing circuit 154 when the ultrasonic sensor 200 in the transmission mode is transmitting no ultrasonic wave. The reception detection signal RDsig is a signal generated based on the reception signal Rsig1 and includes pulses PLrd, each indicating the reception timing when the ultrasonic sensor 200 in the reception mode has received an ultrasonic wave.

For example, based on a result of a comparison between the voltage of the reception signal Rsig1 and the voltage Vth, the signal processing circuit 154 specifies a specific timing at which a voltage of the reception signal Rsig1 based on the voltage Vc becomes equal to or greater than a voltage Vth based on the voltage Vc. The signal processing circuit 154 causes the pulse PLrd to rise at a first timing (for example, a time Ta1) when the voltage of the reception signal Rsig1 becomes equal to or greater than the voltage Vc after the specific timing. The signal processing circuit 154 causes the pulse PLrd to fall at a timing when a time period corresponding to a predetermined high-level period has elapsed since the pulse PLrd rises. The signal processing circuit 154 may cause the pulse PLrd to fall at a timing at which the voltage of the reception signal Rsig1 becomes equal to or less than the voltage Vc for the first time since the pulse PLrd rises.

The measurement signal MTsig includes (i) multiple pulses PLmt that correspond to the respective pulses PLsst included in the subsequent transmission timing signal SSTsig, and (ii) multiple pulses PLmt that correspond to the respective pulses PLrd included in the reception detection signal RDsig. Therefore, the measurement timings of the elapsed time from the time T0 (the reference time) are defined by the respective pulses PLmt of the measurement signal MTsig. In the example illustrated in FIG. 2, the result of logical OR of the subsequent transmission timing signal SSTsig and the reception detection signal RDsig corresponds to the measurement signal MTsig. The time measurer 170 stores the counted number of the clock pulses CLK at each of the measurement timings (times Ta1, Ta2, Ta3, Ta4, and Ta5 in the example illustrated in FIG. 2).

In this example, an ith (i is an integer not less than 1 and not more than N) pulse PLsst included in the subsequent transmission timing signal SSTsig is generated based on a signal obtained by delaying an ith pulse PLrd of the reception detection signal RDsig by a time Dta. Accordingly, for example, a first pulse PLsst included in the subsequent transmission timing signal SSTsig is output from the timing control circuit 132 at the time Ta2 when the time Dta has elapsed from the time Ta1 corresponding to a first pulse PLrd of the reception detection signal RDsig.

Thereafter, a second pulse group PLG is output from the pulse transmission circuit 136 at the time Ta2 defined by a second pulse PLst included in the transmission timing signal STsig (that is, the first pulse PLsst included in the subsequent transmission timing signal SSTsig). As a result, an ultrasonic wave in response to the pulses PLsp included in the second pulse group PLG of the transmission pulse signal SPsig is generated in the ultrasonic sensor 200 in the transmission mode. Transmission of the ultrasonic wave is repeated in this way.

In the example illustrated in FIG. 2, the ultrasonic wave is transmitted from the ultrasonic sensor 200 in the transmission mode at each of the times T0, Ta2, and Ta4. The ultrasonic sensor 200 in the reception mode receives the ultrasonic wave at each of the times Ta1, Ta3, and Ta5. More precisely, each of the times Ta1, Ta3, and Ta5 represents a reception timing detected by the signal processing circuit 154, in which the reception timing corresponding to each time (Ta1, Ta3, and Ta5) represents a timing at which the ultrasonic sensor 200 in the reception mode has received the ultrasonic wave.

Therefore, the time measurer 170 stores multiple count values from the time T0 to the respective times Ta1, Ta2, Ta3, Ta4, and Ta5 as information indicating elapsed times from the time T0 to the times Ta1, Ta2, Ta3, Ta4, and Ta5. The time measurer 170 outputs, to the flow rate calculator 180, the data Dall indicating the count values from the time T0 to the times Ta1, Ta2, Ta3, Ta4, and Ta5 as the time information Tinf indicating the elapsed times.

The flow rate calculator 180 calculates the individual propagation time PT of each of the three transmitted ultrasonic waves using the time information Tinf. For example, the individual propagation time PT1 of the first transmitted ultrasonic wave is the elapsed time (Ta1−T0) from the time T0 to the time Ta1 and is calculated by the product of (i) the count value corresponding to the time Ta1 and (ii) the cycle of the clock pulse CLK. The individual propagation time PT2 of the second transmitted ultrasonic wave is the elapsed time (Ta3−Ta2) from the time Ta2 to the time Ta3 and is calculated by the product of the following (i) and (ii): (i) a value obtained by subtracting the count value corresponding to the time Ta2 from the count value corresponding to the time Ta3, and (ii) the cycle of the clock pulse CLK. The individual propagation time PT3 of the third transmitted ultrasonic wave is the elapsed time (Ta5−Ta4) from the time Ta4 to the time Ta5 and is calculated by the product of the following (i) and (ii): (i) a value obtained by subtracting the count value corresponding to the time Ta4 from the count value corresponding to the time Ta5, and (ii) the cycle of the clock pulse CLK.

In this embodiment, the individual propagation time PT of each of N transmitted ultrasonic waves is calculated. Accordingly, in this embodiment, it is possible to easily determine whether reception timings detected by the signal processing circuit 154 as the timing at which the ultrasonic sensor 200 in the reception mode has received the ultrasonic wave are erroneous.

For example, when a difference between the individual propagation time PT of an ultrasonic wave calculated based on the time information Tinf and an estimated propagation time is equal to or greater than a permissible time, the flow rate calculator 180 determines this individual propagation time PT to be an erroneous individual propagation time PT calculated based on an erroneous reception timing. The estimated propagation time is estimated, for example, based on parameters concerning the pipe PL and the fluid FL, or the like. The permissible time may be, for example, a time based on a cycle TRp of the reception signal Rsig1 corresponding to an ultrasonic wave received by the ultrasonic sensor 200 in the reception mode (and may be, for example, half of the cycle TRp).

The flow rate calculator 180 specifies the propagation time of the ultrasonic wave from the ultrasonic sensor 200 in the transmission mode to the ultrasonic sensor 200 in the reception mode, using individual propagation times PT for which the difference between the respective individual propagation time PT and the estimated propagation time is less than the permissible time, from among the individual propagation times PT of ultrasonic waves calculated based on the time information Tinf. The Individual propagation times PT for Ih the difference between the respective individual propagation time PT and the estimated propagation time is less than the permissible time are, for example, individual propagation times PT other than erroneous individual propagation times PT from among the individual propagation times PT of ultrasonic waves calculated based on the time information Tinf, and such individual propagation times PT other than erroneous individual propagation times comprise an example of “propagation times within a predetermined time range”. For example, the flow rate calculator 180 calculates an average value of the individual propagation times PT of ultrasonic waves calculated based on the time information Tinf, other than the erroneous individual propagation times PT. The flow rate calculator 180 specifies the calculated average value as the measurement result of the propagation time of the ultrasonic wave.

In this embodiment, the measurement result of the propagation time of the ultrasonic wave is specified using the individual propagation times PT of ultrasonic waves calculated based on the time information Tinf, other than the erroneous individual propagation times PT. Therefore, the propagation time of the ultrasonic wave can be accurately measured. Furthermore, in this embodiment, the time information Tinf is transmitted once from the time measurer 170 to the flow rate calculator 180 after N ultrasonic waves are transmitted. Therefore, overhead of data transfer can be reduced as compared to a case in which data is transferred each time the count value is stored. Accordingly, in this embodiment, the number of times of transmission of the ultrasonic wave repeatedly transmitted in a predetermined period can be increased as compared to the case in which data is transferred each time the count value is stored. Otherwise, the time elapsed until the Nth ultrasonic wave is transmitted after the first ultrasonic wave is transmitted can be shortened in this embodiment as compared to the case in which data is transferred each time the count value is stored.

The transmission of the time information Tinf from the time measurer 170 to the flow rate calculator 180 may be performed, for example, during a switching period in which the propagation direction of the ultrasonic wave is switched. In this case, the total measurement time required for the measurement of the propagation time of the ultrasonic wave transmitted in the forward direction and the measurement of the propagation time of the ultrasonic wave transmitted in the reverse direction can be shortened, as compared to a case in which the transmission of the time information Tinf from the time measurer 170 to the flow rate calculator 180 is not performed during the switching period.

In this embodiment, the count value is stored at each of the times T0, Ta2 and Ta4 when the ultrasonic wave is transmitted from the ultrasonic sensor 200 in the transmission mode. Therefore, effects of an error in the time Dta on the measurement accuracy of the propagation time of the ultrasonic wave can be decreased. Accordingly, in this embodiment, for example, it is possible to reduce complication of a delay circuit that delays each of the pulses PLrd of the reception detection signal RDsig by the time Dta.

In this embodiment, as described above, an “i+1”th ultrasonic wave is transmitted after the time Dta has elapsed from reception of an ith ultrasonic wave. Accordingly, in this embodiment, effects of residual vibration of the ultrasonic sensor 200 caused by transmission and reception of the ith ultrasonic wave on transmission and reception of the “i+1”th ultrasonic wave can be decreased. For example, the time Dta is determined so as to avoid the overlap of the vibration of the ultrasonic sensor 200 caused by the transmission and reception of the “i+1”th ultrasonic wave on the residual vibration of the ultrasonic sensor 200 caused by the transmission and reception of the ith ultrasonic wave. Therefore, in this embodiment, it is possible to avoid the signal processing circuit 154 from erroneously detecting the reception timing of the ultrasonic wave. The time Dta may be “0”. In this case, the time required for the measurement of the propagation time of the ultrasonic wave can be shortened.

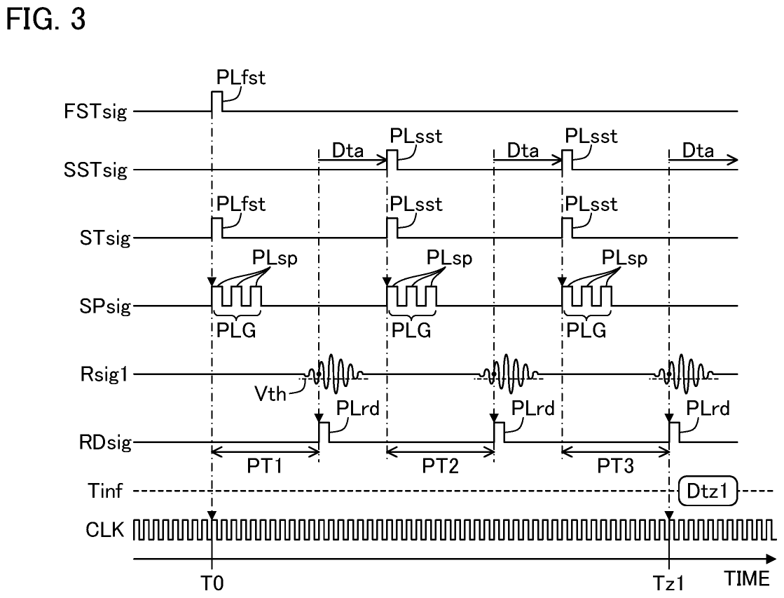

Example timings of various signals in a comparative example to be compared with this embodiment is explained next with reference to FIG. 3.

FIG. 3 is a timing chart for explaining one example of various signals according to a comparative example of the measurement system 10 illustrated in FIG. 1. In the comparative example, it is envisaged that an ultrasonic flowmeter has a time measurer that measures the elapsed time from the reference time to the reception timing of an Nth transmitted ultrasonic wave, instead of the measurement signal output circuit 160 and the time measurer 170 illustrated in FIG. 1. Also in FIG. 3, it is envisaged that the number of times (N times) of transmission of the ultrasonic wave, which is repeatedly transmitted from one of the ultrasonic sensors 200a and 200b to the other ultrasonic sensor, is three.

The first transmission timing signal FSTsig, the subsequent transmission timing signal SSTsig, the transmission timing signal STsig, the transmission pulse signal SPsig, the reception signal Rsig1, and the reception detection signal RDsig are substantially the same as those in the example illustrated in FIG. 2, and explanations thereof are omitted.

In the comparative example illustrated in FIG. 3, the clock pulses CLK are counted from the transmission timing (the time T0) of a first transmitted ultrasonic wave to the reception timing (a time Tz1) of a third transmitted ultrasonic wave. Data Dtz1 indicating the count value from the time T0 to the time Tz1 is output to the flow rate calculator 180 as the time information Tinf indicating the elapsed time from the time T0 to the time Tz1.

In the comparative example, the individual propagation time PT of each of the three transmitted ultrasonic waves is not measured. Therefore, in the comparative example, the propagation time of the ultrasonic wave is represented by “(Tz1−T0−2*Dta)/3” using the elapsed time (Tz1−T0) from the time T0 to the time Tz1 and the time Dta from reception of an ultrasonic wave to transmission of the next ultrasonic wave. Accordingly, in the comparative example, in a case in which an error of the time Dta is large for example, the measurement accuracy of the propagation time of the ultrasonic wave is degraded as compared to a case in which an error of the time Dta is small. Therefore, in the comparative example, the accuracy of the time Dta from reception of an ultrasonic wave to transmission of the next ultrasonic wave needs to be high compared to this embodiment. In other words, the time Dta from reception of an ultrasonic wave to transmission of the next ultrasonic wave is not required to be highly accurate in this embodiment.

In the comparative example, the individual propagation time PT of each of the three transmitted ultrasonic waves is not measured. Therefore, it is difficult to determine whether the reception timing detected by the signal processing circuit 154 as the timing at which the ultrasonic sensor 200 in the reception mode has received an ultrasonic wave is erroneous. Accordingly, in the comparative example, when the signal processing circuit 154 erroneously detects the reception timing, the measurement accuracy of the propagation time of the ultrasonic wave is low compared with this embodiment. A specific example is given in the following.

More specifically, in the specific example, it is envisaged that the actual individual propagation time PT of each of the three transmitted ultrasonic waves is obtained by adding the following (i) and (ii): (i) a time that is 0.2 times as long as the permissible time explained with reference to FIG. 2, and (ii) the estimated propagation time. Furthermore, in the specific example, it is envisaged that the signal processing circuit 154 erroneously detects, as the reception timing of the ultrasonic wave transmitted first, a timing that is 1.5 times as long as the permissible time later than the correct reception timing. In this case, in the comparative example, a difference between (i) the estimated elapsed time obtained by adding a time that is three times as long as the estimated propagation time and a time that is twice as long as the time Dta, and (ii) the elapsed time indicated by the time information Tinf, is a time about 2.1 times as long as the permissible time. Therefore, in the comparative example, the time obtained by adding (i) a time which is 0.7 times as long as the permissible time and (ii) the estimated propagation time is measured as the propagation time of the ultrasonic wave. A difference between the measured propagation time of the ultrasonic wave and the actual propagation time (the time obtained by adding the time 0.2 times as long as the permissible time and the estimated propagation time) is large.

In contrast thereto, in this embodiment, an erroneous individual propagation time PT calculated based on a reception timing erroneously detected by the signal processing circuit 154 is not used for the specification of the measurement result of the propagation time of the ultrasonic wave as explained with reference to FIG. 2. For example, in this embodiment, the flow rate calculator 180 specifies the measurement result of the propagation time of the ultrasonic wave based on the transmission timing and reception timing of each of the second and third transmitted ultrasonic waves in the specific example described above. In this case, the measurement result of the propagation time of the ultrasonic wave specified by the flow rate calculator 180 approximately matches the time obtained by adding the time 0.2 times as long as the permissible time and the estimated propagation time. In this way, in this embodiment, it is possible to reduce degradation in the measurement accuracy of the propagation time of the ultrasonic wave even when the signal processing circuit 154 erroneously detects a reception timing.

In this embodiment, the ultrasonic flowmeter 100 measures the propagation time of the ultrasonic wave transmitted from the ultrasonic sensor 200 in the transmission mode to the ultrasonic sensor 200 in the reception mode. The ultrasonic flowmeter 100 includes (i) the transmitter 130 that causes the ultrasonic sensor 200 in the transmission mode to repeatedly transmit the ultrasonic wave one at a time, (ii) the receiver 150 that detects reception at the ultrasonic sensor 200 in the reception mode, of the ultrasonic wave transmitted from the ultrasonic sensor 200 in the transmission mode, (iii) the time measurer 170 that measures elapsed times for the ultrasonic waves, each of the elapsed times being an elapsed time from a reference time to a reception time of the respective ultrasonic waves received by the ultrasonic sensor 200 in the reception mode, and (iv) the flow rate calculator 180 that calculates the propagation time of the ultrasonic wave from the ultrasonic sensor 200 in the transmission mode to the ultrasonic sensor 200 in the reception mode based on the elapsed times measured by the time measurer 170.

In this embodiment, an ultrasonic time measurement method is a method for measuring the propagation time of the ultrasonic wave transmitted from the ultrasonic sensor 200 in the transmission mode to the ultrasonic sensor 200 in the reception mode. The method includes (i) causing the ultrasonic sensor 200 in the transmission mode to repeatedly transmit ultrasonic waves one at a time, (ii) detecting reception at the ultrasonic sensor 200 in the reception mode, of the respective ultrasonic waves transmitted from the ultrasonic sensor 200 in the transmission mode, (iii) measuring elapsed times for the ultrasonic waves, each of the elapsed times being an elapsed time from a reference time to a reception time of the respective ultrasonic waves received by the ultrasonic sensor 200 in the reception mode, and (iv) calculating the propagation time of the ultrasonic wave from the ultrasonic sensor 200 in the transmission mode to the ultrasonic sensor 200 in the reception mode.

In this embodiment, the elapsed time is measured from the reference time to the reception time of each of ultrasonic waves repeatedly transmitted from the ultrasonic sensor 200 in the transmission mode to the ultrasonic sensor 200 in the reception mode. The propagation time of the ultrasonic wave is calculated based on the measured elapsed times. Accordingly, in this embodiment, even when the reception timing of an ultrasonic wave received by the ultrasonic sensor 200 in the reception mode is erroneously detected, the erroneous detection of the reception timing can be easily determined. Therefore, in this embodiment, the propagation time of the ultrasonic wave can be accurately measured, for example, by specifying the measurement result of the propagation time of the ultrasonic wave without using the individual propagation times PT of ultrasonic waves, for which the reception timing has been erroneously detected.

In this embodiment, the number of times of transmission of the ultrasonic waves repeatedly transmitted from the ultrasonic sensor 200 in the transmission mode is N (N is an integer equal to or greater than 2). The time measurer 170 obtains, as the reference time, a transmission time of an ultrasonic wave transmitted for the first time, from among the ultrasonic waves repeatedly transmitted from the ultrasonic sensor 200 in the transmission mode. The time measurer 170 measures elapsed times from the reference time to transmission times of the ultrasonic waves transmitted for the second and subsequent times from among the ultrasonic waves repeatedly transmitted from the ultrasonic sensor 200 in the transmission mode. After an elapsed time from the reference time to a reception time of the ultrasonic wave transmitted for the Nth time is measured, the time measurer 170 outputs to the flow rate calculator 180, time information Tinf indicating the following (i) and (ii): (i) elapsed times from the reference time to each of reception times of ultrasonic waves transmitted for the first to Nth times, and (ii) elapsed times from the reference time to each of transmission times of the ultrasonic waves transmitted for the second to Nth times.

In this embodiment, the time measurer 170 measures the following (i) and (ii): (i) the elapsed time from the reference time to the reception time of the first transmitted ultrasonic wave, and (ii) the elapsed times from the reference time to the transmission time and the reception time of each of the second and later transmitted ultrasonic waves. Accordingly, in this embodiment, the individual propagation time PT of each of the first to Nth transmitted ultrasonic waves can be easily calculated based on the elapsed times measured by the time measurer 170. Furthermore, since the time measurer 170 measures the elapsed times from the reference time to the transmission times of the second and subsequently transmitted ultrasonic waves in this embodiment, the time Dta from reception of an ultrasonic wave to transmission of the next ultrasonic wave is not required to be highly accurate. In this embodiment, the time information Tinf indicating the elapsed times measured by the time measurer 170 is output to the flow rate calculator 180. Therefore, overhead of data transfer can be reduced relative to a case in which measurement data is transferred each time the elapsed time is measured.

In this embodiment, the flow rate calculator 180 calculates propagation times of the ultrasonic waves repeatedly transmitted from the ultrasonic sensor 200 in the transmission mode, based on the elapsed times measured by the time measurer 170. The flow rate calculator 180 specifies the propagation time of the ultrasonic wave from the ultrasonic sensor 200 in the transmission mode to the ultrasonic sensor 200 in the reception mode using propagation times within a predetermined time range among the propagation times calculated based on the elapsed times measured by the time measurer 170.

In this embodiment, the propagation time of the ultrasonic wave is specified using individual propagation times PT within the predetermined time range among the individual propagation times PT calculated based on the elapsed times measured by the time measurer 170. That is, individual propagation times PT not within the predetermined time range are not used for the specification of the propagation time of the ultrasonic wave in this embodiment. The individual propagation times PT not within the predetermined time range are likely to be the individual propagation times PT of ultrasonic waves, for which the reception timing has been erroneously detected. Therefore, in this embodiment, it is possible to reduce degradation in the measurement accuracy of the propagation time of the ultrasonic wave even in a case of erroneous detection of the reception timing. That is, the propagation time of the ultrasonic wave can be accurately measured even when the reception timing is erroneously detected.

### A2: Second Embodiment

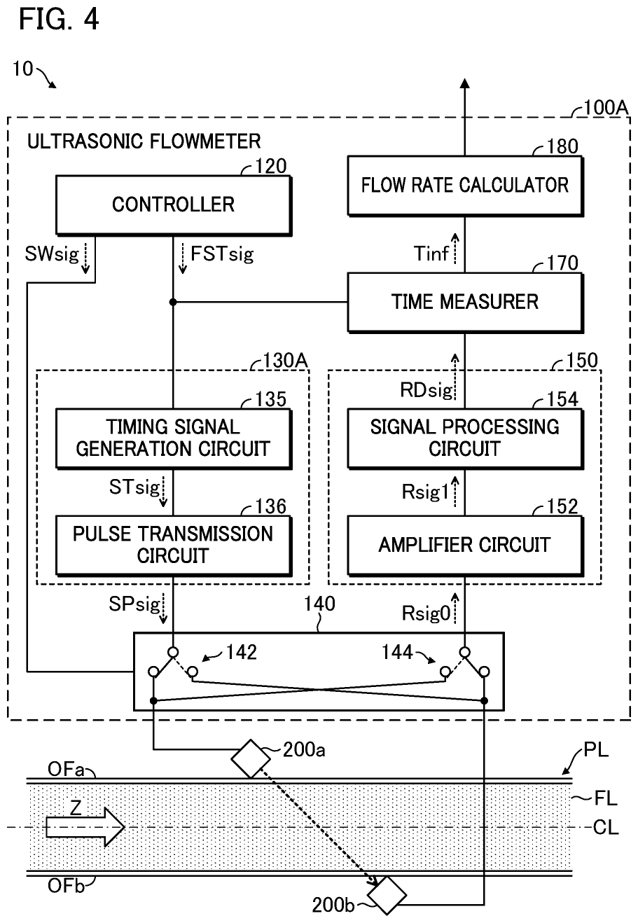

FIG. 4 is an explanatory diagram of an example of the measurement system 10 including an ultrasonic flowmeter 100A according to a second embodiment. The same elements as those described in FIG. 1 to FIG. 3 are denoted by like reference signs and detailed explanations thereof are omitted.

The ultrasonic flowmeter 100A is substantially the same as the ultrasonic flowmeter 100 illustrated in FIG. 1 except for the following (i) and (ii): (i) the measurement signal output circuit 160 illustrated in FIG. 1 is removed from the ultrasonic flowmeter 100 and (ii) a transmitter 130A is included instead of the transmitter 130. The ultrasonic flowmeter 100A is another example of the “ultrasonic time measurement device” and the transmitter 130A is another example of the “transmission circuit”.

The transmitter 130A is substantially the same as the transmitter 130 illustrated in FIG. 1 except that a timing signal generation circuit 135 is included instead of the timing control circuit 132 and the timing signal output circuit 134 illustrated in FIG. 1. That is, the transmitter 130A includes the timing signal generation circuit 135 and the pulse transmission circuit 136.

The timing signal generation circuit 135 receives the first transmission timing signal FSTsig from the controller 120. The timing signal generation circuit 135 generates the transmission timing signal STsig that defines the transmission timing of each of ultrasonic waves repeatedly transmitted with reception of the first transmission timing signal FSTsig as a trigger. The transmission timing signal STsig is output from the timing signal generation circuit 135 to the pulse transmission circuit 136.

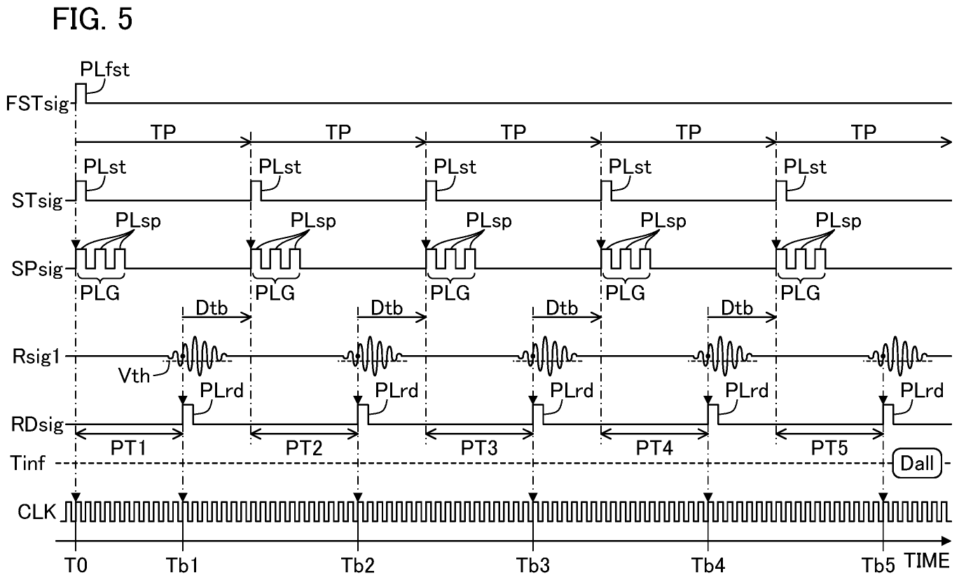

For example, the timing signal generation circuit 135 outputs the transmission timing signal STsig having the pulse PLst with a cycle TP illustrated in FIG. 5 to the pulse transmission circuit 136 upon receipt of the first transmission timing signal FSTsig. That is, the pulse PLst of the transmission timing signal STsig is repeatedly output with the cycle TP from the timing signal generation circuit 135 to the pulse transmission circuit 136 regardless of the detection result of the reception timing of the ultrasonic wave by the signal processing circuit 154 of the receiver 150. In this embodiment, the cycle TP of the pulse PLst is an example of a “predetermined cycle” and the transmission timing signal STsig is an example of a “transmission clock”. The pulse PLst may be interpreted as the “transmission clock”.

It is preferable that the accuracy (for example, frequency accuracy, jitter, and the like) of the pulse PLst of the transmission timing signal STsig be high. For example, it is preferable that the accuracy of the pulse PLst of the transmission timing signal STsig be an accuracy substantially the same as or higher than the resolution of the propagation time measurement of the ultrasonic wave. Specifically, it is preferable that the accuracy of the pulse PLst of the transmission timing signal STsig be equal to or greater than the accuracy of the clock pulses CLK. For example, the pulse PLst of the transmission timing signal STsig may be generated using the clock pulses CLK.

In this embodiment, the transmitter 130A causes the ultrasonic sensor 200 in the transmission mode to repeatedly transmit the ultrasonic wave synchronously with the pulse PLst with the cycle TP contained in the transmission timing signal STsig.

The time measurer 170 receives, for example, the first transmission timing signal FSTsig from the controller 120 and receives the reception detection signal RDsig from the receiver 150. The time measurer 170 measures the elapsed time from the reference time to the reception time of the ultrasonic wave based on the first transmission timing signal FSTsig and the reception detection signal RDsig. For example, the time measurer 170 starts counting the clock pulses CLK in response to a receipt of the first transmission timing signal FSTsig. The time measurer 170 stores the count values each obtained at each of the reception timings of the ultrasonic wave indicated by the reception detection signal RDsig.

In this embodiment, among the transmission timings and the reception timings of ultrasonic wave, only the reception timings of ultrasonic waves are measurement timings at which the count value is stored by the time measurer 170. Accordingly, in this embodiment, for example, even when the number of count values stored by the time measurer 170 is five, which is equal to that in the example illustrated in FIG. 2, the number of times of transmission of the ultrasonic wave can be increased to be more than that in the example illustrated in FIG. 2 as illustrated in FIG. 5 (described later).

The time measurer 170 outputs to the flow rate calculator 180, for example, the time information Tinf indicating the elapsed time from the reference time to the reception time of each of first to Nth transmitted ultrasonic waves after the elapsed time from the reference time to the reception time of the Nth transmitted ultrasonic wave is measured. The calculation method of the individual propagation time PT of the ultrasonic wave by the flow rate calculator 180 is explained with reference to FIG. 5.

The configurations of the measurement system 10 and the ultrasonic flowmeter 100A are not limited to the example illustrated in FIG. 1. For example, the timing signal generation circuit 135 may be included in the controller 120 or may be included in the pulse transmission circuit 136.

Example timings of various signals for measuring the propagation time of the ultrasonic wave in this embodiment are explained next with reference to FIG. 5.

FIG. 5 is a timing chart for explaining examples of signals in the measurement system 10 illustrated in FIG. 4. In FIG. 5, example timings of different signals for measuring the propagation time of the ultrasonic wave transmitted in one of the forward direction and the reverse direction is illustrated similarly in FIG. 2. In FIG. 5, it is envisaged that five count values are stored by the time measurer 170 similarly in FIG. 2. Further, in FIG. 5, it is envisaged that the number of times (N times) of transmission of the ultrasonic wave, which is repeatedly transmitted from one of the ultrasonic sensors 200a and 200b to the other ultrasonic sensor, is five.

The first transmission timing signal FSTsig, the transmission pulse signal SPsig, the reception signal Rsig1, and the reception detection signal RDsig are substantially the same as those in the example illustrated in FIG. 2 and explanations thereof are omitted.

The transmission timing signal STsig includes the pulses PLst that each define each of transmission timings of the ultrasonic wave repeatedly transmitted. The cycle TP of the pulse PLst is determined, for example, based on the estimated propagation time, or the like, so as to prevent vibration of the ultrasonic sensor 200 caused by transmission and reception of an “i+1”th ultrasonic wave from being superimposed on residual vibration of the ultrasonic sensor 200 caused by transmission and reception of an ith ultrasonic wave. Accordingly, in this embodiment, it is possible to avoid the signal processing circuit 154 from erroneously detecting the reception timing of the ultrasonic wave. In this embodiment, the cycle TP is set by the timing signal generation circuit 135. However, a time Dtb from reception of the ith ultrasonic wave to transmission of the “i+1”th ultrasonic wave is not particularly set to a certain time.

The pulse groups PLG included in the transmission pulse signal SPsig are output from the pulse transmission circuit 136 at timings defined by the pulses PLst of the transmission timing signal STsig. Therefore, the pulse group PLG is repeatedly output with the cycle TP from the pulse transmission circuit 136. Accordingly, an ultrasonic wave is repeatedly transmitted with the cycle TP from the ultrasonic sensor 200 in the transmission mode. The ultrasonic sensor 200 in the reception mode repeatedly receives the ultrasonic wave.

A first pulse group PLG among the pulse groups PLG repeatedly transmitted with the cycle TP is output from the pulse transmission circuit 136 at the time T0 defined by a first pulse PLst of the transmission timing signal STsig. Therefore, the time T0 corresponds to the transmission time of a first ultrasonic wave among the ultrasonic waves repeatedly transmitted with the cycle TP.

In this embodiment, the time T0 defined by the first pulse PLst of the transmission timing signal STsig corresponds to the time defined by the pulse PLfst of the first transmission timing signal FSTsig. Therefore, also in this embodiment, the time measurer 170 starts counting the clock pulses CLK at the time T0.

In the example illustrated in FIG. 5, the ultrasonic sensor 200 in the reception mode receives the ultrasonic wave at each of times Tb1, Tb2, Tb3, Tb4, and Tb5. Therefore, the time measurer 170 stores each of count values from the time T0 to the times Tb1, Tb2, Tb3, Tb4, and Tb5 as information indicating each of elapsed times from the time T0 to the times Tb1, Tb2, Tb3, Tb4, and Tb5. The time measurer 170 outputs, to the flow rate calculator 180, the data Dall indicating multiple count values from the time T0 to the respective times Tb1, Tb2, Tb3, Tb4, and Tb5 as the time information Tinf indicating the elapsed times.

The flow rate calculator 180 calculates the individual propagation time PT of each of the five transmitted ultrasonic waves using the time information Tinf. For example, the individual propagation time PT1 of the first transmitted ultrasonic wave is the elapsed time (Tb1−T0) from the time T0 to the time Tb1 and is calculated by the product of (i) the count value corresponding to the time Tb1 and (ii) the cycle of the clock pulse CLK. The individual propagation time PT2 of the second transmitted ultrasonic wave is the elapsed time (Tb2−(T0+TP)) from the transmission time (T0+TP) of the second transmitted ultrasonic wave to the time Tb2. Therefore, the individual propagation time PT2 of the second transmitted ultrasonic wave is calculated by subtracting the time corresponding to the cycle TP from the product of (i) the count value corresponding to the time Tb2 and (ii) the cycle of the clock pulse CLK.

The individual propagation time PT3 of the third transmitted ultrasonic wave is the elapsed time (Tb3−(T0+2*TP)) from the transmission time (T0+2*TP) of the third transmitted ultrasonic wave to the time Tb3. Therefore, the individual propagation time PT3 of the third transmitted ultrasonic wave is calculated by subtracting a time corresponding to twice the length of the cycle TP from the product of (i) the count value corresponding to the time Tb3 and (ii) the cycle of the clock pulse CLK. The individual propagation time PT4 of the fourth transmitted ultrasonic wave is the elapsed time (Tb4−(T0+3*TP)) from the transmission time (T0+3*TP) of the fourth transmitted ultrasonic wave to the time Tb4. Therefore, the individual propagation time PT4 of the fourth transmitted ultrasonic wave is calculated by subtracting a time corresponding to three times the length of the cycle TP from the product of (i) the count value corresponding to the time Tb4 and (ii) the cycle of the clock pulse CLK.

The individual propagation time PT5 of the fifth transmitted ultrasonic wave is the elapsed time (Tb5−(T0+4*TP)) from the transmission time (T0+4*TP) of the fifth transmitted ultrasonic wave to the time Tb5. Therefore, the individual propagation time PT5 of the fifth transmitted ultrasonic wave is calculated by subtracting a time corresponding to four times the length of the cycle TP from the product of (i) the count value corresponding to the time Tb5 and (ii) the cycle of the clock pulse CLK.

In this embodiment, the individual propagation time PT of each of N transmitted ultrasonic waves is calculated. Accordingly, the same effects as those of the first embodiment described above can be obtained also in this embodiment. In this embodiment, the time measurer 170 stores the count value corresponding to the reception timing of the ultrasonic wave, without storing the count value corresponding to the transmission timing of the ultrasonic wave. Accordingly, in this embodiment, for example, when the number of the count values stored by the time measurer 170 is equal to that in the first embodiment described above, the number of times of transmission of the ultrasonic wave can be increased as compared to that in the first embodiment. Therefore, in this embodiment, the resolution of the measurement result of the propagation time of the ultrasonic wave can be enhanced.

As described above, in this embodiment, the transmitter 130A causes the ultrasonic sensor 200 in the transmission mode to repeatedly transmit the ultrasonic wave synchronously with the pulse PLst with the cycle TP. The time measurer 170 sets the transmission time of a first transmitted ultrasonic wave among ultrasonic waves repeatedly transmitted from the ultrasonic sensor 200 in the transmission mode as the reference time. The time measurer 170 then measures the elapsed time from the reference time to the reception time of an Nth transmitted ultrasonic wave. The time measurer 170 subsequently outputs the time information Tinf indicating the elapsed time from the reference time to the reception time of each of the first to Nth transmitted ultrasonic waves, to the flow rate calculator 180. The flow rate calculator 180 calculates the propagation time of the ultrasonic wave from the ultrasonic sensor 200 in the transmission mode to the ultrasonic sensor 200 in the reception mode, based on the cycle TP and the elapsed times measured by the time measurer 170.

In this embodiment, the individual propagation time PT of each of N transmitted ultrasonic waves is calculated based on the cycle TP and the elapsed times measured by the time measurer 170. Accordingly, the same effects as those of the first embodiment described above can be obtained also in this embodiment. In this embodiment, since the time measurer 170 does not need to measure the elapsed time from the reference time to the transmission time of each ultrasonic wave, the number of times of transmission of the ultrasonic wave relative to the number of times of measurement of the elapsed time by the time measurer 170 can be increased. Accordingly, in this embodiment, for example, even when the number of times of measurement of the elapsed time by the time measurer 170 is equal to that in the first embodiment, the resolution of the measurement result of the propagation time of the ultrasonic wave can be enhanced.

### B: Modifications

The embodiments described above can be modified in various ways. Specific modifications which can be applied to the embodiments described above are exemplified below. Two or more modes optionally selected from the following exemplifications may be combined with each other as long as they do not conflict.

### B1: First Modification

In the first and second embodiments, the controller 120 may vary the number of times of transmission of the ultrasonic wave repeatedly transmitted from the ultrasonic sensor 200 in the transmission mode. For example, the flow rate calculator 180 calculates the flow velocity of the fluid FL based on the propagation time of the ultrasonic wave that is transmitted from the ultrasonic sensor 200 in the transmission mode and that propagates through the fluid FL to be received by the ultrasonic sensor 200 in the reception mode, as described in the foregoing embodiments. The controller 120 then sets a variable number of times of transmission of the ultrasonic wave repeatedly transmitted based on the flow velocity of the fluid FL calculated by the flow rate calculator 180.

In this modification, the controller 120 varies the number of times of transmission of the ultrasonic wave repeatedly transmitted depending on the flow velocity of the fluid FL calculated by the flow rate calculator 180. For example, when the flow velocity of the fluid FL calculated by the flow rate calculator 180 is low, the controller 120 increases the number of times of transmission of the ultrasonic wave repeatedly transmitted as compared to a case in which the flow velocity of the fluid FL is high. Specifically, when the flow velocity of the fluid FL is low, the controller 120 increases the number of times of transmission of the ultrasonic wave repeatedly transmitted to enable the error ratio of the time resolution to the flow velocity of the fluid FL to be constant. Accordingly, in this modification, the propagation time of an ultrasonic wave can be calculated with the number of times of transmission suitable for the flow velocity in the next measurement (calculation) of the flow velocity of the fluid FL. That is, the propagation time of an ultrasonic wave can be measured with a resolution suitable for the flow velocity in the next measurement (calculation) of the flow velocity of the fluid FL. In this modification, the controller 120 is an example of a “setter”.

### B2: Second Modification

In the embodiments and the modification, an example is given in which the time information Tinf indicating all the elapsed times measured by the time measurer 170 is output to the flow rate calculator 180 after measurement of the Nth transmitted ultrasonic wave ends. However, the present disclosure is not limited to this mode. For example, each time a predetermined number of times of measurement of the elapsed time ends, the time measurer 170 may output to the flow rate calculator 180, the time information Tinf indicating a predetermined number of measured elapsed times, when the predetermined number corresponds to the predetermined number of times of the measurement. Alternatively, the time measurer 170 may output, each time the elapsed time is measured, the time information Tinf indicating the measured elapsed time to the flow rate calculator 180.

As described above, also in this modification, the same effects as those of the embodiments and the modification described above can be obtained. However, in this modification, in some cases, overhead of data transfer may be increased as compared to the embodiments and modification described above.

### B3: Third Modification

In the embodiments and the modifications, an example is given in which the individual propagation times PT to be used for specification of the propagation time of the ultrasonic wave are selected from among the individual propagation times PT of the ultrasonic wave based on the estimated propagation time and the permissible time. However, the present disclosure is not limited to this mode. The flow rate calculator 180 may use an average (so-called “trimmed mean”) calculated with individual propagation times PT of the ultrasonic wave calculated based on the time information Tinf, other than a predetermined number of the longest and shortest individual propagation times, as the propagation time of the ultrasonic wave.

As described above, also in this modification, the same effects as those of the embodiments and the modifications described above can be obtained.

### B4: Fourth Modification

In the embodiments and the modifications, the ultrasonic flowmeters 100 and 100A have been described as the “ultrasonic time measurement device”. However, the “ultrasonic time measurement device” is not limited to the ultrasonic flowmeter. That is, the measurement system 10 is not limited to a system that measures the flow rate of a fluid FL in a pipe PL using ultrasonic waves. The measurement system 10 may be a system that measures the flow velocity of a fluid FL in a pipe PL using ultrasonic waves. In this case, the measurement system 10 has a flow velocity measurement device that measures the flow velocity of the fluid FL using the propagation time of the ultrasonic wave, as the “ultrasonic time measurement device”. For example, the measurement system 10 may be a system that measures acoustic properties (the acoustic velocity, the acoustic impedance, and the like) of a material using ultrasonic waves. In this case, the measurement system 10 has a device that measures the acoustic properties of a material using the propagation time of the ultrasonic wave as the “ultrasonic time measurement device”. As described above, also in this modification, the same effects as those of the embodiments and the modifications described above can be obtained.

### Description of Reference Signs

10 . . . measurement system, 100, 100A . . . ultrasonic flowmeter, 120 . . . controller, 130, 130A . . . transmitter, 132 . . . timing control circuit, 134 . . . timing signal output circuit, 135 . . . timing signal generation circuit, 136 . . . pulse transmission circuit, 140 . . . switcher, 142, 144 . . . switch, 150 . . . receiver, 152 . . . amplifier circuit, 154 . . . signal processing circuit, 160 . . . measurement signal output circuit, 170 . . . time measurer, 180 . . . flow rate calculator, 200a, 200b . . . ultrasonic sensor, FL . . . fluid, PL . . . pipe.

What is claimed is:

1. An ultrasonic time measurement device that measures a propagation time of a measurement wave transmitted from a first sensor to a second sensor, the device comprising:
a transmission circuit configured to cause the first sensor to repeatedly transmit measurement waves one at a time;
a reception circuit configured to detect reception at the second sensor, of the respective measurement wave transmitted from the first sensor;
a time measurer configured to measure elapsed times for the measurement waves, each of the elapsed times being an elapsed time from a reference time to a reception time of the respective measurement wave received by the second sensor; and
a calculator configured to calculate the propagation time of the measurement wave from the first sensor to the second sensor based on the elapsed times measured by the time measurer.

2. The ultrasonic time measurement device according to claim 1, wherein:
the number of times of transmission of the measurement wave repeatedly transmitted from the first sensor is N (N is an integer equal to or greater than 2), and
the time measurer is configured to:
obtain, as the reference time, a transmission time of a measurement wave transmitted for the first time, from among the measurement waves repeatedly transmitted from the first sensor;
measure elapsed times from the reference time to transmission times of the measurement waves transmitted for the second and subsequent times from among the measurement waves repeatedly transmitted from the first sensor, and
after an elapsed time from the reference time to a reception time of the measurement wave transmitted for the Nth time is measured, output to the calculator, time information indicating:
elapsed times from the reference time to each of reception times of measurement waves transmitted for the first to Nth times, and
elapsed times from the reference time to each of transmission times of the measurement waves transmitted for the second to Nth times.

3. The ultrasonic time measurement device according to claim 1, wherein:
the number of times of transmission of the measurement waves repeatedly transmitted from the first sensor is N (N is an integer equal to or greater than 2),
the transmission circuit is configured to cause the first sensor to repeatedly transmit the measurement waves synchronously with a transmission clock with a predetermined cycle,
the time measurer is configured to:
obtain, as the reference time, a transmission time of a measurement wave transmitted for the first time, from among the measurement waves repeatedly transmitted from the first sensor, and
after an elapsed time from the reference time to a reception time of a measurement wave transmitted for the Nth time is measured, output to the calculator, time information indicating elapsed times, each of the elapsed times being an elapsed time from the reference time to each of reception times of measurement waves transmitted for the first to Nth times, and
the calculator is configured to calculate the propagation time of the measurement wave from the first sensor to the second sensor based on the predetermined period and the elapsed times measured by the time measurer.

4. The ultrasonic time measurement device according to claim 1,
wherein the calculator is configured to:
calculate propagation times of the measurement waves repeatedly transmitted from the first sensor based on the elapsed times measured by the time measurer, and
specify the propagation time of the measurement wave from the first sensor to the second sensor using propagation times within a predetermined time range among the propagation times calculated based on the elapsed times measured by the time measurer.

5. The ultrasonic time measurement device according to claim 1, further comprising a setter configured to vary the number of times of transmission of the measurement waves repeatedly transmitted from the first sensor, wherein:
the calculator is configured to calculate a flow velocity of a fluid based on a propagation time of a measurement wave transmitted from the first sensor and propagating through the fluid and received by the second sensor, from among the measurement waves repeatedly transmitted from the first sensor, and
the setter is configured to vary the number of times of transmission of the measurement waves based on the flow velocity of the fluid calculated by the calculator.

6. The ultrasonic time measurement device according to claim 5, wherein when the flow velocity of the fluid calculated by the calculator is low, the setter is configured to increase the number of times of transmission of the measurement waves repeatedly transmitted as compared to when the flow velocity of the fluid is high.

7. An ultrasonic time measurement method for measuring a propagation time of a measurement wave transmitted from a first sensor to a second sensor, the method comprising:
causing the first sensor to repeatedly transmit measurement waves one at a time;
detecting reception at the second sensor, of the respective measurement wave transmitted from the first sensor;
measuring elapsed times for the measurement waves, each of the elapsed times being an elapsed time from a reference time to a reception time of the respective measurement wave received by the second sensor; and
calculating the propagation time of the measurement wave from the first sensor to the second sensor based the measured elapsed times.
